(19) United States
(12) Patent Application Publication
(10) Pub. No.: US 2015/0264188 A1
(43) Pub. Date: Sep. 17, 2015

(54) TELEPHONY SYSTEM COMPRISING A MASTER DEVICE AND AT LEAST ONE SLAVE DEVICE CONNECTED BY A COMMUNICATION NETWORK

(71) Applicant: SAGEMCON BROADBAND SAS, Rueil Malmaison (FR)

(72) Inventors: Fabrice Cluzeau, Rueil-Malmaison (FR); Olivier Beneze, Rueil-Malmaison (FR)

(21) Appl. No.: 14/434,417

(22) PCT Filed: Oct. 8, 2013
(86) PCT No.: PCT/EP2013/070914

§ 371 Date: Apr. 9, 2015

(30) Foreign Application Priority Data
Oct. 10, 2012 (FR) 12/59674

(51) Int. Cl. H04M 7/12; H04M 7/00

(52) U.S. Cl. CPC H04M 7/128; H04M 7/009; H04M 7/129

(57) ABSTRACT

A telephony system including a plurality of devices including a master device and at least one slave device connected by a communication network, the system being intended to be connected to at least one telephone line and to at least one telephone terminal, each device including at least one telephone interface adapted for connecting at least one respective telephone line and/or a telephone interface adapted for connecting at least one respective telephone terminal. The master device including a telephone call management module, said devices switch to the telephone call management module any event issuing from a telephone interface and relating to an incoming call or to an outgoing call, and switch to a telephone interface any command sent by the telephone call management and addressed to said telephone interface.

The present invention concerns a telephony system comprising a plurality of devices including a master device and at least one slave device connected by a communication network, said system being intended to be connected to at least one telephone line and to at least one telephone terminal.

At the present time, needs for access to one or more telephone lines and for sharing this telephone line are ever changing, within a dwelling or in a company. To allow dealing with such changes in needs, telephone networks are typically deployed within the dwelling or company so as to increase the number of FXS (Foreign eXchange Subscriber) ports available for connecting telephone terminals. In this way for example the number of telephone wall sockets in the dwelling or company is increased. It should be noted that fax and modem are types of telephone terminals. Furthermore, current residential gateways generally have one or two FXS ports, and potentially a port of the DECT (Digital Enhanced Cordless Telephone) or CAT-IQ (Cordless Advanced Technology—Internet Quality) type or a USB (Universal Serial Bus) interface adapted for managing a USB DECT key. These residential gateways thus increase the availability of connectivity, but this still poses the problem of the possibility of further developments. In addition, when several telephone lines are geographically distributed in a building, this poses a problem of actual sharing of the telephone lines and application of common call management rules.

It is desirable to overcome these drawbacks of the prior art. It is in particular desirable to provide a telephony solution that is scalable and enables easily homogenising the management of telephone calls. It is further desirable to provide a solution that is simple to implement and the deployment of which is effective in terms of resources and cost.

The invention concerns a telephony system comprising a plurality of devices including a master device and at least one slave device linked by a communication network, the system being intended to be connected to at least one telephone line and to at least one telephone terminal, each device comprising at least one telephone interface adapted for connecting at least one respective telephone line and/or a telephone interface adapted for connecting at least one respective telephone terminal. The system is such that the master device comprises a telephone call management module and that said devices are adapted for switching to the telephone call management module any event issuing from a telephone interface and relating to an incoming call or to an outgoing call, and that said devices are further adapted for switching to a telephone interface any command issued by the telephone call management module and addressed to said telephone interface. Thus, by virtue of such a centralised implementation of the telephone call management module, the call management is homogenised within the telephone system. Such an implementation of slave devices offers the possibility of easily developing the telephone connectivity of the telephone system effectively. This is because it suffices to increase or reduce the number of slave devices without having to completely reparameterise the telephone call management rules.

According to a particular embodiment, each event and each command transmitted via the communication network is transmitted in the form of a message, and there exists a bijective relationship between events and commands on the one hand and messages on the other hand.

According to a particular embodiment, each device comprises an interface management module adapted for performing a transcription between events and commands on the one hand and messages on the other hand, and the interface management module of the master device is further adapted for transmitting to the telephone call management module any event issuing from a telephone interface and relating to an incoming call or to an outgoing call and for receiving from the telephone call management module any command addressed to a telephone interface.

According to a particular embodiment, each interface management module further comprises means for managing connection of voice data through the communication network.

According to a particular embodiment, the telephone call management module comprises means for analysing the outgoing call number, and each device is adapted for switching to the telephone call management module an event representing each digit dialled by a telephone terminal's user and detected by a said telephone interface to which said telephone terminal is connected.

According to a particular embodiment, each slave device comprises: means for detecting unavailability of the master device via the communication network and, when the unavailability of the master device is detected, the following means are implemented: means for generating a busy tone via a telephone interface adapted for connecting at least one telephone terminal, in response to receiving a handset off-hooking representative event via said telephone interface.

According to a particular embodiment, the telephone call management module implements, upon receiving a handset offhooking event coming from a telephone interface adapted for connecting a telephone terminal: means for transmitting a dialling invitation tone activation command addressed to said telephone interface, when at least one telephone line is free; means for transmitting a busy tone activation command addressed to said telephone interface, when no telephone line is free.

The invention also concerns a method implemented by a telephony system comprising a plurality of devices including a master device and at least one slave device linked by a communication network, said system being connected to at least one telephone line and to at least one telephone terminal, each device comprising at least one telephone interface connected to at least one respective telephone line and/or a telephone interface connected to at least one respective telephone terminal. The method is further such that, the master device comprising a telephone call management module, said devices switch to the telephone call management module any event issuing from a telephone interface and relating to an incoming call or to an outgoing call, and switch to a telephone interface any command issued by the telephone call management module and addressed to said telephone interface.

The features of the invention mentioned above, as well as others, will emerge more clearly from a reading of the following description of an example embodiment, said description being given in relation to the accompanying drawings, among which:

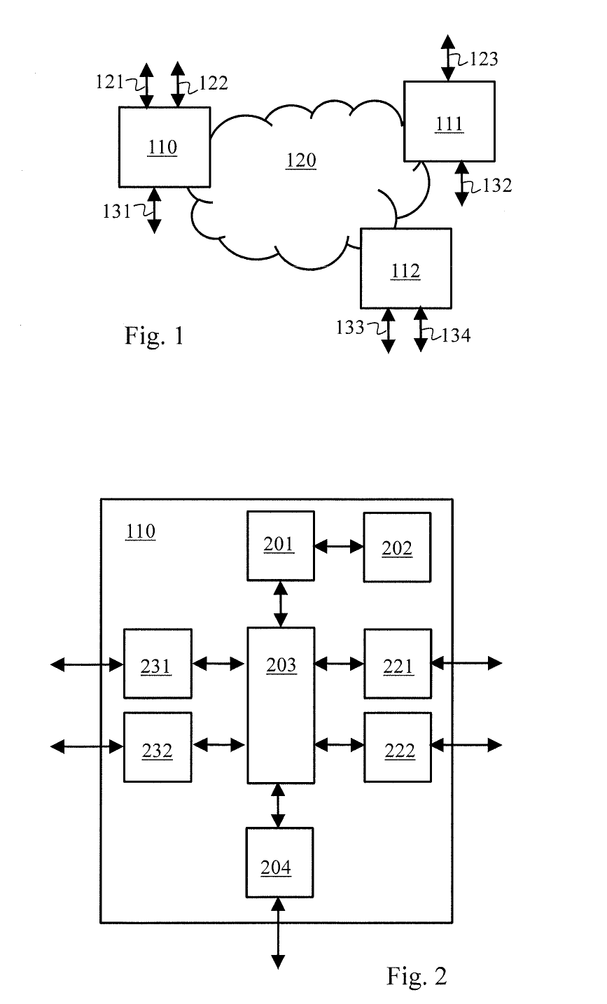

FIG. 1 schematically illustrates a telephony system according to the present invention;

FIG. 2 schematically illustrates a master device of the telephony system;

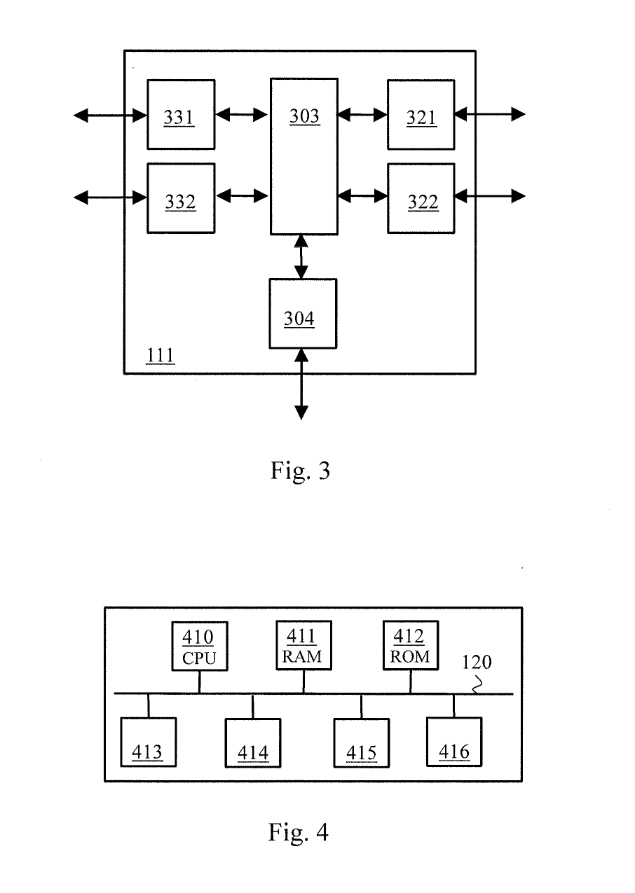

FIG. 3 schematically illustrates a slave device of the telephony system;

FIG. 4 schematically illustrates an example of hardware architecture of the master device and/or of the slave device;

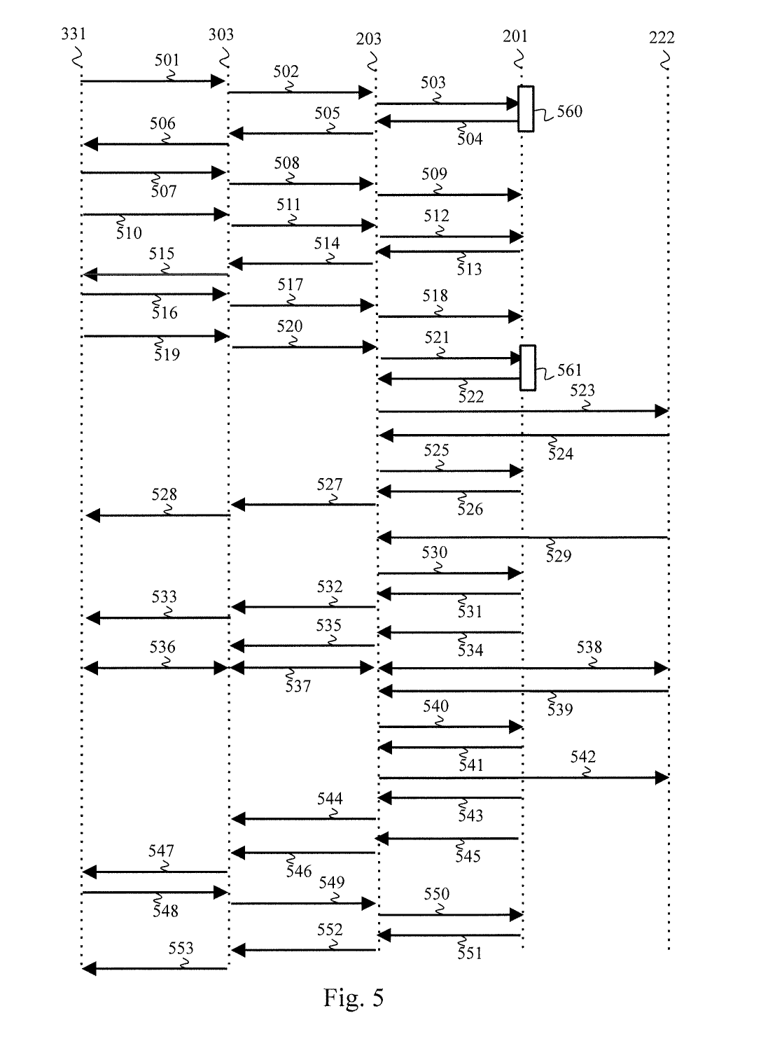

FIG. 5 schematically illustrates a first example of exchanges implemented in the telephony system in the context of an outgoing call;

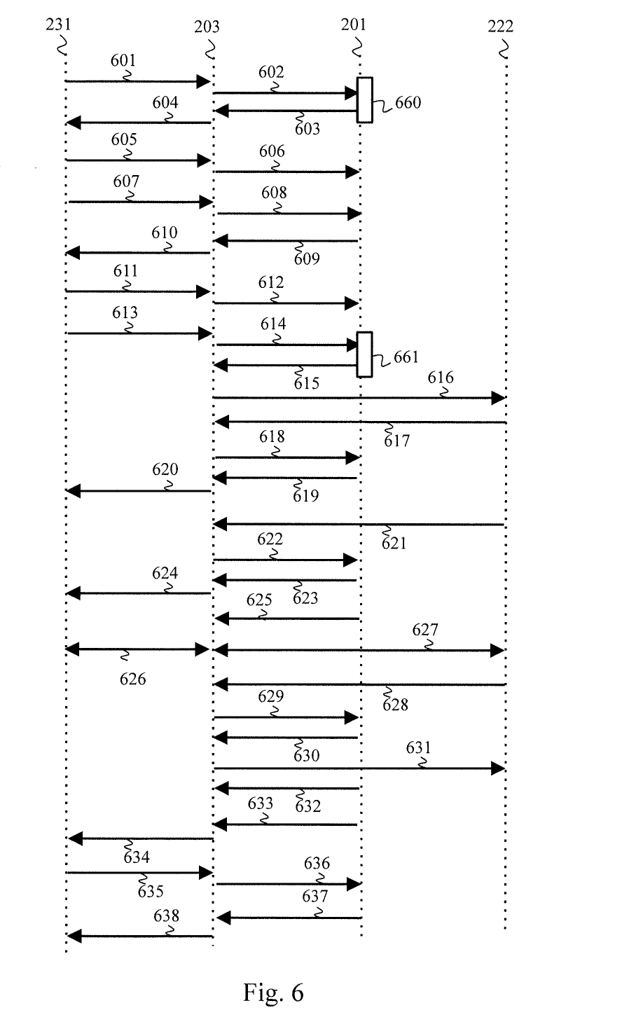

FIG. 6 schematically illustrates a second example of exchanges implemented in the telephony system in the context of an outgoing call;

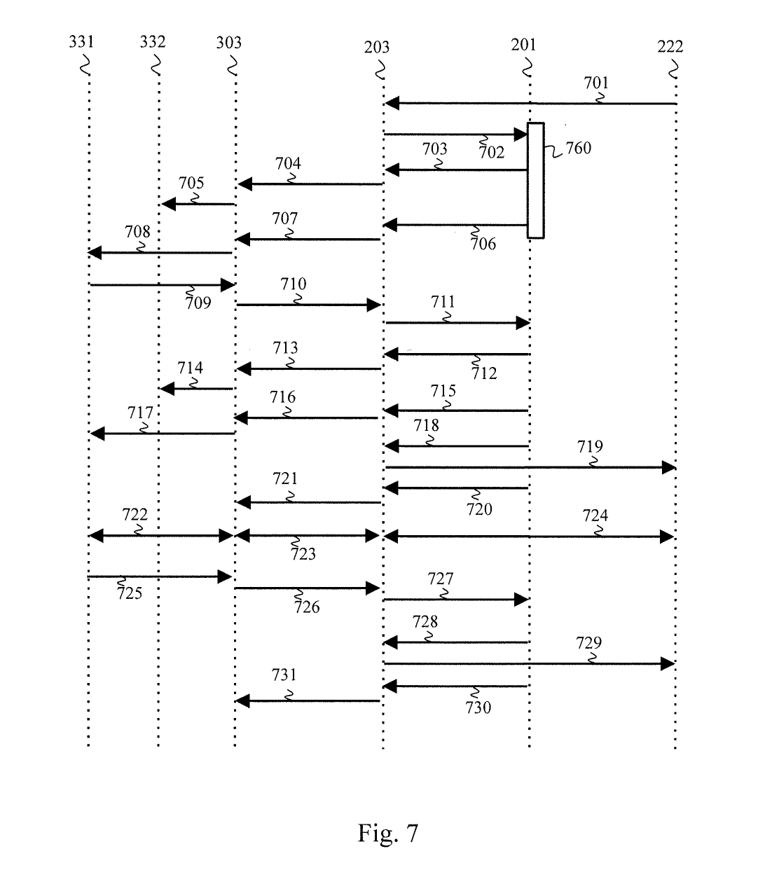

FIG. 7 schematically illustrates a first example of exchanges implemented in the telephony system in the context of an incoming call;

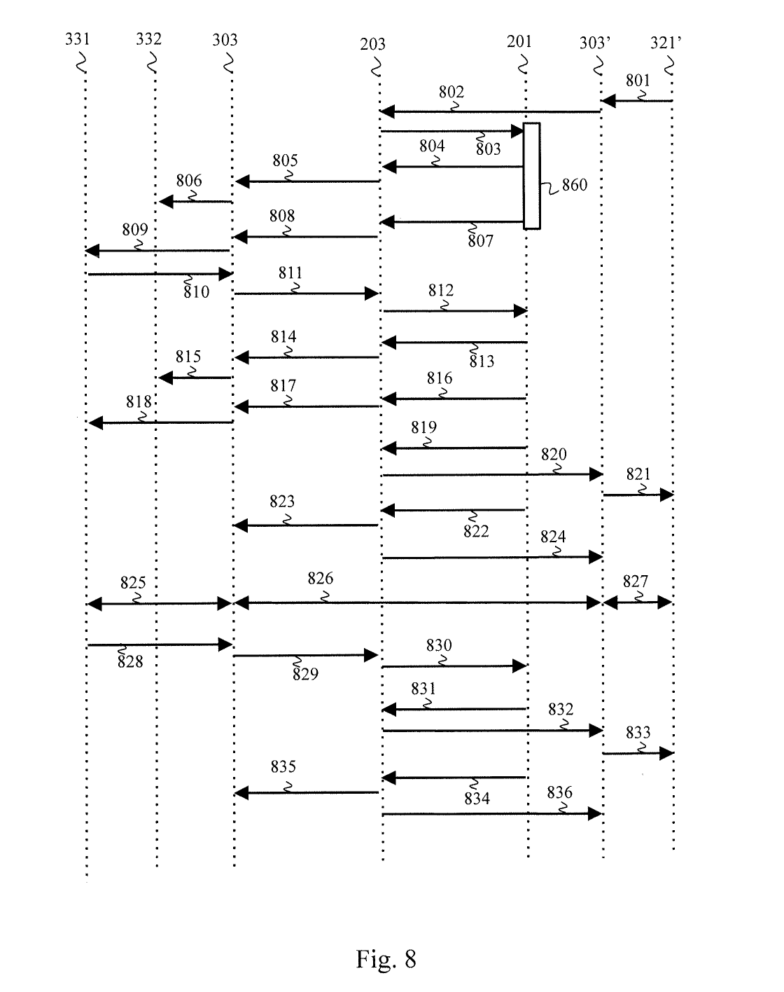

FIG. 8 schematically illustrates a second example of exchanges implemented in the telephony system in the context of an incoming call.

FIG. 1 schematically illustrates a telephony system according to the present invention. The telephony system comprises a plurality of devices connected by a communication network 120, including a master device 110 and at least one slave device 111, 112. The telephony system preferably comprises a plurality of slave devices. The communication network 120 is preferably a packet communication network, for example of the WiFi (registered trademark) type. The master device 110 is more fully described hereafter in relation to FIG. 2 and the slave device 111 is more fully described hereafter in relation to FIG. 3.

The telephony system is intended to be connected to at least one telephone line. In FIG. 1, connections with three telephone lines are depicted: a first connection 121 between a first telephone line and the master device 110, a second connection 122 between a second telephone line and the master device 110, and a third connection 123 between a third telephone line and the slave device 111.

The telephone system is intended to be connected to at least one telephone terminal, and preferentially a plurality of telephone terminals. In FIG. 1, connections with four telephone terminals are depicted: a first connection 131 between a first telephone terminal and the master device 110, a second connection 132 between a second telephone terminal and the slave device 111 and a third connection 133 between a third telephone terminal and the slave device 112.

Each device of the telephone system comprises at least one telephone interface adapted for connecting at least one respective telephone line and/or a telephone interface adapted for connecting at least one respective telephone terminal.

FIG. 2 schematically illustrates the master device 110. The master device 110 may comprise one or more telephone interfaces 231, 232 adapted for connecting telephone terminals. Each of these telephone interfaces 231, 232 is either of the digital type or of the analogue type. An interface of the analogue type is for example of the FXS type, meaning a port adapted for supplying the tone, the load current and the electrical voltage necessary for operating the ringing of an analogue telephone terminal that is connected thereto. An interface of the digital type is for example a DECT interface or a USB interface adapted for managing a USB DECT key. The master device 110 may comprise no telephone interface adapted for establishing connections with telephone terminals.

The master device 110 may comprise one or more telephone interfaces 221, 222 adapted for connecting telephone lines. Each of these telephone interfaces 221, 222 is either of the digital type or of the analogue type. An interface of the analogue type is said to be FXO (Foreign eXchange Office), meaning a signalling telephone interface managing signals of the POTS (Plain Old Telephone Service) type. An interface of the digital type is for example an SIP interface (Session Initiation Protocol) in the context of a VOIP (Voice over Internet Protocol) service. The master device 110 may comprise no telephone interface adapted for establishing connections with telephone lines.

The master device 110 comprises a communication interface 204 adapted for connecting the master device 110 to the communication network 120 and thus for enabling the master device 110 to exchange data with each slave device 111,112. When these data are messages representing commands or events, a transport protocol such as TCP (Transmission Control Protocol) or UDP (User Datagram Protocol) can be used. When these data are voice data, a transport protocol such as RTP (Real-time Transport Protocol) may be used.

The master device 110 comprises a telephone call management module 201 adapted for controlling the telephony system according to events coming from any telephone line and any telephone terminal that are connected thereto. The telephone call management module 201 is adapted for controlling the implementation of incoming calls and outgoing calls within the telephone system, on the basis of predetermined rules stored by a configuration unit 202 included in the master device 110. The configuration unit 202 may be directly included in the telephone call management module 201.

An outgoing call is a telephone call initiated by a telephone terminal connected to the telephony system and intended for a distant telephone terminal via a telephone line connected to the telephony system. An incoming call is a telephone call initiated by a distant telephone terminal via a telephone line connected to the telephony system and intended for a telephone terminal connected to the telephony system.

The predetermined rules serve to determine the behaviour of the telephony system in the context of incoming or outgoing calls, according to a state of availability of the telephone terminals or of the telephone lines respectively. For example, said predetermined rules define whether, when all the telephone terminals are busy, the incoming call must be redirected to a voice server or messaging service, or whether a busy signal must be returned to the distant telephone terminal that initiated the call. According to another example, said predetermined rules define whether the incoming call shall imply ringing of each of the telephone terminals connected to the system, or whether only some of them are concerned.

The master device 110 comprises an interface management module 203 adapted for receiving events coming from the telephone interfaces 221, 222, 231, 232, for transmitting commands to the telephone interfaces 221, 222, 231, 232, for receiving events in the form of messages via the communication interface 204, and for transmitting commands in the form of messages via the communication interface 204. The interface management module 203 is further adapted for forwarding received events to the call management module 201, and for receiving from the call management module 201 commands to be forwarded. The function of the interface management module 203 is therefore to switch data, such as events and commands, but also voice data, when a call involving at least one of the telephone interfaces 221, 222, 231, 232 is established.

The expression “forwarding” may mean relaying an event or a command as received or relaying an event or command after transcription into another format. It should however be noted that there exists a bijective relationship between what is received and what is relayed. In particular there exists a bijective relationship between events and commands on the one hand and messages on the other hand.

The master device 110 has knowledge of each slave device in the system. This knowledge may be static or dynamic, for example by implementing a discovery protocol on the communication network 120, such as the SSDP (Simple Service Discovery Protocol). The predetermined rules stored by the configuration unit 202 may thus change according to modifications to the topology of the communication network 120, e.g. appearance or disappearance of a device.

FIG. 3 schematically illustrates the slave device 111. Any other slave device in the telephony system is arranged according to the same scheme.

The slave device 111 may comprise one or more telephone interfaces 331, 332 adapted for establishing connections with telephone terminals. Each of these telephone interfaces 331, 332 is either of the digital type or of the analogue type. The slave device 111 may comprise no telephone interface adapted for establishing connections with telephone terminals.

The slave device 111 may comprise one or more telephone interfaces 321, 322 adapted for establishing connections with telephone lines. Each of these telephone interfaces 321, 322 is either of the digital type or of the analogue type. The slave device 111 may comprise no telephone interface adapted for establishing connections with telephone lines.

The slave device 111 comprises a communication interface 304 adapted for connecting the slave device 111 to the communication network 120 and thus enables the slave device 111 to exchange data with the master device 110 and any other slave device in the telephony system.

The slave device 111 comprises an interface management module 303 adapted for receiving events coming from the telephone interfaces 321, 322, 331, 332, and for forwarding them in the form of messages to the master device 110 via the communication interface 304. The interface management module 303 is also adapted for receiving commands in the form of messages via the communication interface 304, coming from the master device 110, and for forwarding them to the telephone interfaces 321, 322, 331, 332. The function of the interface management module 303 is therefore to switch data, such as events and commands, but also voice data, when a call is established involving at least one of the telephone interfaces 321, 322, 331, 332.

In view of FIGS. 2 and 3, the devices in the system are adapted for switching, to the telephone call management module 201, any event issuing from a telephone interface and relating to an incoming call or to an outgoing call, and for switching to a telephone interface any command sent by the telephone call management module 201 and addressed to said telephone interface. In other words, the interface management modules 203, 303 do not have any call management logic strictly speaking, but simply proceed with relays and optionally transcriptions of messages, events and commands.

Preferentially, each interface management module 203, 303 is adapted for performing a transcription between events and commands on the one hand and messages on the other hand. In addition, the interface management module 203 is further adapted for transmitting, to the telephone call management module 201, any event issuing from a telephone interface and relating to an incoming call or to an outgoing call and for receiving from the telephone call management module 201 any command addressed to a telephone interface.

FIG. 4 schematically illustrates an example of hardware architecture of the master device 110. The master device 110 then comprises, connected by a communication bus 420: a processor or CPU (Central Processing Unit) 410; a random access memory RAM 411; a read only memory ROM 412; a storage unit or a storage medium reader, such as an SD (Secure Digital) card reader 413; a first interface 414 enabling communicating via the communication network 120; potentially a second interface 415 enabling connecting at least one telephone line; and potentially a third interface 416 enabling connecting at least one telephone terminal.

Each slave device of the telephone system may have a similar hardware architecture.

The processor 410 is capable of executing instructions loaded into RAM 411 from ROM 412, an external memory (not shown), a storage medium or a communications network. When the master device 110 is powered up, the processor 410 is capable of reading instructions from RAM 411 and executing them. These instructions form a computer program causing the implementation, by the processor 410, of all or some of the algorithms and steps described hereafter. All or some of the algorithms and steps described hereafter may be implemented in software form by the execution of a set of instructions by a programmable machine, such as DSP (Digital Signal Processor) or a microcontroller, or be implemented in hardware form by a machine or a dedicated component, such as an FPGA (Field-Programmable Gate Array) or an ASIC (Application-Specific Integrated Circuit).

FIGS. 5 to 8 present examples of exchanges implemented in the telephony system in the context of outgoing calls and ingoing calls. It will be apparent in these examples that the telephone call management module 201 comprises means for analysing an outgoing call number, and each device in the system is adapted for switching, to the telephone call management module 201, the events respectively representing each digit dialled by a telephone terminal user and detected by a telephone interface to which said telephone terminal is connected.

FIG. 5 schematically illustrates a first example of exchanges implemented in the telephony system in the context of an outgoing call. Let us consider the case of an outgoing call initiated from a telephone terminal connected to the telephone interface 331 of the slave device 111.

In a step 501, the user offhooks the handset of said telephone terminal, which generates an event at the telephone interface 331, which is propagated to the interface management module 303. The interface management module 303 transcribes this event into a corresponding message and transmits this message to the interface management module 203 in a step 502. The interface management module 203 transcribes this message as a corresponding event and transmits this event to the telephone call management module 201 in a step 503.

In a following step 560, the telephone call management module 201 determines, according to the predetermined rules stored by the configuration unit 202, the behaviour of the telephone system when receiving such an event. For example, the rules may define that, if at least one telephone line is free, a telephone line is allocated to the outgoing call, preferably allocating a digital telephone line. Let us consider the case where a telephone line connected to the telephone interface 222 is allocated.

In a following step 504, the telephone call management module 201 transmits, to the interface management module 203, a dialling invitation tone activation command, which is intended for the telephone interface 331. The interface management module 203 transcribes this command as a corresponding message and transmits this message to the interface management module 303 in a step 505. The interface management module 303 transcribes the message as a dialling invitation tone activation command and transmits this command to the telephone interface 331 in a step 506.

In a step 507, in response to the dialling invitation tone, the user presses on the “0” button of the handset, which generates a DTMF (Dual-Tone Multi-Frequency) signalling event at the telephone interface 331, which is propagated to the interface management module 303. The interface management module 303 transcribes this event as a corresponding message and transmits this message to the interface management module 203 in a step 508. The interface management module 203 transcribes this message as a corresponding event and transmits this event to the telephone call management module 201 in a step 509.

In a step 510, the user stops pressing on the “0” button of the handset, which generates a DTMF signalling event at the telephone interface 331, which is propagated to the interface management module 303. The interface management module 303 transcribes this event as a corresponding message and transmits this message to the interface management module 203 in a step 511. The interface management module 203 transcribes this message as a corresponding event and transmits this event to the telephone call management module 201 in a step 512. In a step 513, the telephone call management module 201, potentially according to the predetermined rules stored by the configuration unit 202, in response transmits to the interface management module 203 a command to deactivate the dialling invitation tone, which is intended for the telephone interface 331. The interface management module 203 transcribes this command as a corresponding message and transmits this message to the interface management module 303 in a step 514. The interface management module 303 transcribes the message as a dialling invitation tone deactivation command and transmits this command to the telephone interface 331 in a step 515.

In a step 516, in response to the deactivation of the dialling invitation tone, the user presses on the “1” button of the handset, which generates a DTMF signalling event at the telephone interface 331, which is propagated to the interface management module 303. The interface management module 303 transcribes this event as a corresponding message and transmits this message to the interface management module 203 in a step 517. The interface management module 203 transcribes this message as a corresponding event and transmits this event to the telephone call management module 201 in a step 518.

In a step 519, the user stops pressing on the “1” button of the handset, which generates a DTMF signalling event at the telephone interface 331, which is propagated to the interface management module 301 The interface management module 303 transcribes this event as a corresponding message and transmits this message to the interface management module 203 in a step 520. The interface management module 203 transcribes this message as a corresponding event and transmits this event to the telephone call management module 201 in a step 521.

In a following step 561, the telephone call management module 201 determines, according to the predetermined rules stored by the configuration unit 202, the behaviour of the telephone system when receiving such an event. Let us consider the case where the dialled telephone number “01” is identified as complete according to said predetermined rules.

In a following step 522, the telephone call management module 201 transmits to the interface management module 203 an invitation command, which is intended for the telephone interface 222. The interface management module 203 forwards this command to the telephone interface 222 in a step 523, which causes the sending, over the concerned telephone line, of signalling signals or messages inviting a distant terminal to which the dialled telephone number “01” corresponds to establish a telephone communication.

In response, in a step 524, signalling signals or messages, indicating that the distant terminal is ringing are received from the telephone line, which generates an event at the telephone interface 222, which is propagated to the interface management module 203. The interface management module 203 forwards this event to the telephone call management module 201 in a step 525. In a step 526, the telephone call management module 201, potentially according to the predetermined rules stored by the configuration unit 202, in response transmits to the interface management module 203 a ringing tone activation command, which is intended for the telephone interface 331. The interface management module 203 transcribes this command as a corresponding message and transmits this message to the interface management module 303 in a step 527. The interface management module 303 transcribes the message as a ringing tone activation command, and transmits this command to the telephone interface 331 in a step 528.

In a step 529, signalling signals, or messages, indicating that the distant terminal has offhooked are received from the telephone line, which generates an event at the telephone interface 222, which is propagated to the interface management module 203. The interface management module 203 forwards this event to the telephone call management module 201 in a step 530. In a step 531, the telephone call management module 201, potentially according to the predetermined rules stored by the configuration unit 202, in response transmits to the interface management module 203 a ringing tone deactivation command that is intended for the telephone interface 331. The interface management module 203 transcribes this command as a corresponding message and transmits this message to the interface management module 303 in a step 532. The interface management module 303 transcribes the message as a ringing tone deactivation command and transmits this command to the telephone interface 331 in a step 533.

In a step 534, the telephone call management module 201 transmits, to the interface management module 203, a command to create a voice data path between the telephone interface 222 and the telephone interface 331. The interface management module 203 configures the master device 110 to enable the path to be established. The interface management module 203 transcribes this command as a corresponding message and transmits this message to the interface management module 303 in a step 535. The interface management module 203 and the interface management module 303 then interact to enable the path to be established via the communication network 120. The interface management module 303 configures the slave device 111 to enable the path to be established.

The telephone communication between the telephone terminals is then established: voice data are transmitted from the telephone interface 331 to the interface management module 303 (step 536), then relayed by the interface management module 303 to the interface management module 203 (step 537), and then relayed by the interface management module 203 to the telephone interface 222 (step 538); in the reverse direction, voice data are transmitted from the telephone interface 222 to the interface management module 203 (step 538), then relayed by the interface management module 203 to the interface management module 303 (step 537), and then relayed by the interface management module 303 to the telephone interface 331 (step 536).

Let us consider the case where the distant telephone terminal ends the telephone communication. In a step 539, signalling signals or messages indicating that the distant terminal has been onhooked are received from the telephone line, which generates an event at the telephone interface 222, which is propagated to the interface management module 203. The interface management module 203 forwards this event to the telephone call management module 201 in a step 540. In a step 541, the telephone management module 201, potentially according to the predetermined rules stored by the configuration unit 202, in response transmits to the interface management module 203 an acknowledgement command, which is intended for the telephone interface 222. The interface management module 203 forwards this command to the telephone interface 222 in a step 542, which causes the sending, over the concerned telephone line, of signalling signals, or messages, acknowledging the end of the telephone communication.

In a step 543, the telephone call management module 201 transmits, to the interface management module 203, a command to release the voice data path between the telephone interface 222 and the telephone interface 331. The interface management module 203 configures the master device 110 to enable the path to be released. The interface management module 203 transcribes this command as a corresponding message and transmits this message to the interface management module 303 in a step 544. The interface management module 203 and the interface management module 303 then interact to release the path previously created via the communication network 120. The interface management module 303 configures the slave device 111 so as to release the path.

In a step 545, the telephone call management module 201, potentially according to predetermined rules stored by the configuration unit 202, transmits to the interface management module 203 a busy tone activation command, which is intended for the telephone interface 331. The interface management module 203 transcribes this command as a corresponding message and transmits this message to the interface management module 303 in a step 546. The interface management module 303 transcribes the message as a busy tone activation command and transmits this command to the telephone interface 331 in a step 547.

In a step 548, in response to the busy tone, the user hangs up the handset of the telephone terminal connected to the telephone interface 331, which generates an event at the telephone interface 331, which is propagated to the interface management module 303. The interface management module 303 transcribes this event as a corresponding message and transmits this message to the interface management module 203 in a step 549. The interface management module 203 transcribes this message as a corresponding event and transmits this event to the telephone call management module 201 in a step 550. In a step 551, the telephone call management module 201, potentially according to the predetermined rules stored by the configuration unit 202, in response transmits to the interface management module 203 a busy tone deactivation command, which is intended for the telephone interface 331. The interface management module 203 transcribes this command as a corresponding message and transmits this message to the interface management module 303 in a step 552. The interface management module 303 transcribes the message as a busy tone deactivation command and transmits this command to the telephone interface 331 in a step 553.

FIG. 6 schematically illustrates a second example of exchanges used in the telephone system in the context of an outgoing call. Let us consider the case of an outgoing call initiated from an analogue telephone terminal connected to the telephone interface 232 of the master device 110.

In a step 601, a user offhooks the handset of the analogue telephone terminal, which generates an event at the telephone interface 232, which is propagated to the interface management module 203. The interface management module 203 forwards this event to the telephone call management module 201 in a step 602.

In a following step 660, the telephone call management module 201 determines, according to the predetermined rules stored by the configuration unit 202, the behaviour of the telephone system when receiving such an event. For example, the rules may define that, if at least one telephone line is free, a telephone is allocated to the outgoing call, preferably allocating a digital telephone line. Let us consider the case where a telephone line connected to the telephone interface 222 is allocated.

In a following step 603, the telephone call management module 201 transmits to the interface management module 203 a dialling invitation tone activation command that is intended for the telephone interface 232. The interface management module 203 forwards this command to the telephone interface 232 in a step 604.

In a step 605, in response to the dialling invitation tone, the user presses on the “0” button of the handset, which generates a DTMF signalling event at the telephone interface 232, which is propagated to the interface management module 203. The interface management module 203 forwards this event to the telephone call management module 201 in a step 606.

In a step 607, the user stops pressing on the “0” button of the handset, which generates a DTMF signalling event at the telephone interface 232, which is propagated to the interface management module 203. The interface management module 203 forwards this event to the telephone call management module 201 in a step 608. In a step 609, the telephone call management module 201, potentially according to the predetermined rules stored by the configuration unit 202, in response transmits to the interface management module 203 a dialling invitation tone deactivation command, which is intended for the telephone interface 232. The interface management module 203 forwards this command to the telephone interface 232 in a step 610.

In a step 611, in response to the dialling invitation tone deactivation, the user presses on the “1” button of the handset, which generates a DTMF signalling event at the telephone interface 232, which is propagated to the interface management module 203. The interface management module 203 forwards this event to the telephone call management module 201 in a step 612.

In a step 613, the user stops pressing on the “1” button of the handset, which generates a DTMF signalling event at the telephone interface 232, which is propagated to the interface management module 203. The interface management module 203 forwards this event to the telephone call management module 201 in a step 614.

In a step following step 661, the telephone call management module 201 determines, according to the predetermined rules stored by the configuration unit 202, the behaviour of the telephony system when receiving such an event. Let us consider, as before, the case where the telephone number “01” dialled is identified as complete according to said predetermined rules.

In a following step 615, the telephone call management module 201 transmits to the interface management module 203 an invitation command that is intended for the telephone interface 222. The interface management module 203 forwards this command to the telephone interface 222 in a step 616, which causes the transmission over the telephone line concerned of signalling signals, or messages, inviting a distant terminal to which the dialled telephone number “01” corresponds to establish a telephone communication.

In response, in a step 617, signalling signals, or messages, indicating that the distant terminal is ringing are received from the telephone line, which generates an event at the telephone interface 222, which is propagated to the interface management module 203. The interface management module 203 forwards this event to the telephone call management module 201 in a step 618. In a step 619, the telephone call management module 201, potentially according to the predetermined rules stored by the configuration unit 202, in response transmits to the interface management module 203 a ringing tone activation command that is intended for the telephone interface 232. The interface management module 203 forwards this command to the telephone interface 232 in a step 620.

In a step 621, signalling signals, or messages, indicating that the distant terminal has been offhooked are received from the telephone line, which generates an event at the telephone interface 222, which is propagated to the interface management module 203. The interface management module 203 forwards this event to the telephone call management module 201 in a step 662. In a step 623, the telephone call management module 201, potentially according to the predetermined rules stored by the configuration unit 202, in response transmits to the interface management module 203 a ringing tone deactivation command, which is intended for the telephone interface 232. The interface management module 203 forwards this command to the telephone interface 232 in a step 624.

In a step 625, the telephone call management module 201 transmits to the interface management module 203 a command to create a voice data path between the telephone interface 222 and the telephone interface 232. The interface management module 203 configures the master device 110 to establish the path.

The telephone communication between the telephone terminals is then established: voice data are transmitted from the telephone interface 232 to the interface management module 203 (step 626) and then relayed by the interface management module 203 to the telephone interface 222 (step 627); in the reverse direction, voice data are transmitted from the telephone interface 222 to the interface management module 203 (step 627), and then relayed by the interface management module 203 to the telephone interface 232 (step 626).

Let us consider the case where the distant telephone terminal ends the telephone communication. In a step 628, signalling signals, or messages, indicating that the distant terminal has been onhooked are received from the telephone line, which generates an event at the telephone interface 222, which is propagated to the interface management module 203. The interface management module 203 forwards this event to the telephone call management module 201 in a step 629. In a step 630, the telephone call management module 201, potentially according to the predetermined rules stored by the configuration unit 202, in response transmits to the interface management module 203 an acknowledgement command, which is intended for the telephone interface 222. The interface management module 203 forwards this command to the telephone interface 222 in a step 631, which causes the transmission over the concerned telephone line of signalling signals, or messages, acknowledging the end of the telephone communication.

In a step 632, the telephone call management module 201 transmits to the interface management module 203 a command to release the voice data path between the telephone interface 222 and the telephone interface 232. The interface management module 203 configures the master device 110 to release the path.

In a step 633, the telephone management module 201, potentially according to the predetermined rules stored by the configuration unit 202, transmits to the interface management module 203 a busy tone activation command, which is intended for the telephone interface 232. The interface management module 203 forwards this command to the telephone interface 232 in a step 634.

In a step 635, in response to the busy tone, the user onhooks the handset of the telephone terminal connected to the telephone interface 232, which generates an event at the telephone interface 232, which is propagated to the interface management module 203. The interface management module 203 forwards this event to the telephone call management module 201 in a step 636. In a step 637, the telephone call management module 201, potentially according to the predetermined rules stored by the configuration unit 202, in response transmits to the interface management module 203 a busy tone deactivation command intended for the telephone interface 232. The interface management module 203 forwards this command to the telephone interface 232 in a step 631.

FIG. 7 schematically illustrates a first example of exchanges made in the telephone system in the context of an incoming call. Les us consider the case of an incoming call via a telephone line connected to the telephone interface 222 of the master device 110.

In a step 701, signalling signals, or messages, representing an invitation command coming from a distant terminal are received from the telephone line, which generates an event at the telephone interface 222, which is propagated to the interface management module 203. The interface management module 203 forwards this event to the telephone call management module 201 in a step 702.

In a following step 760, the telephone call management module 201 determines, according to the predetermined rules stored by the configuration unit 202, the behaviour of the telephone system when receiving such an event. For example, the rules may define that, upon detecting an incoming call, all or some of the telephone terminals that are onhooked are called on to ring. Let us consider the case where the telephone terminals connected to the telephone interfaces 331, 332 of the slave device 111 are called on to ring.

In a following step 703, the telephone call management module 201 transmits to the interface management module 203 a ringing activation command that is intended for the telephone interface 332. The interface management module 203 transcribes this command as a corresponding message and transmits this message to the interface management module 303 in a step 704. The interface management module 303 transcribes the message as a ringing activation command and transmits this command to the telephone interface 332 in a step 705. The same scheme is reproduced for each of the telephone terminals to be made to ring. Thus, in a step 706, the telephone call management module 201 transmits to the interface management module 203 a ringing activation command that is intended for the telephone interface 331. The interface management module 203 transcribes this command as a corresponding message and transmits this message to the interface management module 303 in a step 707. The interface management module 303 transcribes the message as a ringing activation command and transmits this command to the telephone interface 331 in a step 708. Let us consider the case where a user offhooks the handset of the telephone terminal connected to the telephone interface 331.

In a step 709, a user offhooks the handset of said telephone terminal, which generates an event at the telephone interface 331, which is propagated to the interface management module 303. The interface management module 303 transcribes this event as a corresponding message and transmits this message to the interface management module 203 in a step 710. The interface management module 203 transcribes this message as a corresponding event and transmits this event to the telephone call management module 201 in a step 711. In a step 712, the telephone call management module 201, potentially according to predetermined rules stored by the configuration unit 202, in response transmits to the interface management module 203 a ringing deactivation command that is intended for the telephone interface 332. The interface management module 203 transcribes this command as a corresponding message and transmits this message to the interface management module 303 in a step 713. The interface management module 303 transcribes the message as a ringing deactivation command and transmits this command to the telephone interface 332 in a step 714. The same scheme is reproduced for each of the telephone terminals to which a ringing activation command has been sent. Thus, in a step 715, the telephone call management module 201 transmits to the interface management module 203 a ringing deactivation command that is intended for the telephone interface 331. The interface management module 203 transcribes this command as a corresponding message and transmits this message to the interface management module 303 in a step 716. The interface management module 303 transcribes the message as a ringing deactivation command and transmits this command to the telephone interface 331 in a step 717.

In a step 718, the telephone call management module 201 transmits to the interface management module 203 an event representing said handset offhooking, which is intended for the telephone interface 222. The interface management module 203 forwards this command to the telephone interface 222 in a step 719, which causes the sending over the concerned telephone line of signalling signals, or messages, representing said handset offhooking.

In a step 720, the telephone call management module 201 transmits to the interface management module 203 a command to create a voice data path between the telephone interface 222 and the telephone interface 331. The interface management module 203 configures the master device 110 to enable the path to be established. The interface management module 203 transcribes this command as a corresponding message and transmits this message to the interface management module 303 in a step 721. The interface management module 203 and the interface management module 303 then interact to allow the establishment of the path via the communication network 120. The interface management module 303 configures the slave device 111 to enable the path to be established.

The telephone communication between the telephone terminals is then established: voice data are transmitted from the telephone interface 331 to the interface management module 303 (step 722), then relayed by the interface management module 303 to the interface management module 203 (step 723), and then relayed by the interface management module 203 to the telephone interface 222 (step 724); in the opposite direction, voice data are transmitted from the telephone interface 222 to the interface management module 203 (step 724), then relayed by the interface management module 203 to the interface management module 303 (step 723), and then relayed by the interface management module 303 to the telephone interface 331 (step 722).

Let us consider the case where the telephone terminal connected to the telephone interface 331 ends the telephone communication. In a step 725, the user onhooks the handset of said telephone terminal, which generates an event at the telephone interface 331 that is propagated to the interface management module 303. The interface management module 303 transcribes this event as a corresponding message and transmits this message to the interface management module 203 in a step 726. The interface management module 203 transcribes this message as a corresponding event and transmits this event to the telephone call management module 201 in a step 727. In a step 728, the telephone call management module 201, potentially according to the predetermined rules stored by the configuration unit 202, in response transmits to the interface management module 203 an event representing said handset onhooking, which is intended for the telephone interface 222. The interface management module 203 forwards this command to the telephone interface 222 in a step 729, which causes the sending, over the concerned telephone line, of signalling signals, or messages, representing said handset onhooking.

In a step 730, the telephone call management module 201 transmits to the interface management module 203 a command to release the voice data path between the telephone interface 222 and the telephone interface 331. The interface management module 203 configures the master device 110 to enable the path to be released. The interface management module 203 transcribes this command as a corresponding message and transmits this message to the interface management module 303 in a step 731. The interface management module 203 and the interface management module 303 then interact so as to release the path previously created via the communication network 120. The interface management module 303 configures the slave device 111 so as to release the path.

FIG. 8 schematically illustrates a second example of exchanges implemented in the telephony system in the context of an incoming call. Let us consider the case of an incoming call via a telephone line connected to the telephone interface 321 of the slave device 112. Let us denote this telephone interface 321 of the slave device 112 as 321′ in order not to confuse it with the telephone interface 321 of the slave device 111. Likewise, let us denote the interface management module of the slave device 112 as 303′ in order not to confuse it with the interface management module 303 of the slave device 111.

In a step 801, signalling signals, or messages, representing an invitation command coming from a distant terminal are received from the telephone line, which generates an event at the telephone interface 321′, which is propagated to the interface management module 303′. The interface management module 303′ transcribes this event as a corresponding message and transmits this message to the interface management module 203 in a step 802. The interface management module 203 transcribes this message as a corresponding event and transmits this event to the telephone call management module 201 in a step 803.

In a following step 860, the telephone call management module 201 determines, according to the predetermined rules stored by the configuration unit 202, the behaviour of the telephony system when receiving such an event. For example, the rules may define that, upon detecting an incoming call, all or some of the telephone terminals onhooked are called on to ring. Let us consider the case where the telephone terminals connected to the telephone interfaces 331, 332 of the slave device 111 are called on to ring.

In a following step 804, the telephone call management module 201 transmits to the interface management module 203 a ringing activation command that is intended for the telephone interface 332. The interface management module 203 transcribes this command as a corresponding message and transmits this message to the interface management module 303 in a step 805. The interface management module 303 transcribes the message as a ringing activation command and transmits this command to the telephone interface 332 in a step 806. The same scheme is reproduced for each of the telephone terminals to be made to ring. Thus, in a step 807, the telephone call management module 201 transmits to the interface management module 203 a ringing activation command that is intended for the telephone interface 331. The interface management module 203 transcribes this command as a corresponding message and transmits this message to the interface management module 303 in a step 808. The interface management module 303 transcribes the message as a ringing activation command and transmits this command to the telephone interface 331 in a step 809. Let us consider, as before, the case where a user offhooks the handset of the telephone terminal connected to the telephone interface 331.

In a step 810, a user offhooks the handset of said telephone terminal, which generates an event at the telephone interface 331, which is propagated to the interface management module 303. The interface management module 303 transcribes this event as a corresponding message and transmits this message to the interface management module 203 in a step 811. The interface management module 203 transcribes this message as a corresponding event and transmits this event to the telephone call management module 201 in a step 812. In a step 813, the telephone call management module 201, potentially according to predetermined rules stored by the configuration unit 202, in response transmits to the interface management module 203 a ringing deactivation command that is intended for the telephone interface 332. The interface management module 203 transcribes this command as a corresponding message and transmits this message to the interface management module 303 in a step 814. The interface management module 303 transcribes the message as a ringing deactivation command and transmits this command to the telephone interface 332 in a step 815. The same scheme is reproduced for each of the telephone terminals to which a ringing activation command had been sent. Thus, in a step 816, the telephone call management module 201 transmits to the interface management module 203 a ringing deactivation command that is intended for the telephone interface 331. The interface management module 203 transcribes this command as a corresponding message and transmits this message to the interface management module 303 in a step 817. The interface management module 303 transcribes the message as a ringing deactivation command and transmits this command to the telephone interface 331 in a step 818.

In a step 819, the telephone call management module 201 transmits to the interface management module 203 an event representing said handset offhooking, which is intended for the telephone interface 321′. The interface management module 203 transcribes this event as a corresponding message and transmits this message to the interface management module 303′ in a step 820. The interface management module 303′ transcribes the message as an event representing said handset offhooking and transmits this event to the telephone interface 321′ in a step 821, which causes the sending, over the concerned telephone line, of signalling signals, or messages, representing said handset offhooking.

In a step 822, the telephone call management module 201 transmits to the interface management module 203 a command to create a voice data path between the telephone interface 331 and the telephone interface 321′. The interface management module 203 transcribes this command as a message and transmits this message to the interface management module 303 in a step 823, as well as to the interface management module 303′ in a step 824. The interface management module 303 and the interface management module 303′ then interact to establish the path via the communication network 120. The interface management module 303 configures the slave device 11 and the interface management module 303′ configures the slave device 112 to establish the path.

The telephone communication between the telephone terminals is then established: voice data are transmitted from the telephone interface 331 to the interface management module 303 (step 825), then relayed by the interface management module 303 to the interface management module 303′ (step 826), and then relayed by the interface management module 303′ to the telephone interface 321′ (step 827); in the reverse direction, voice data are transmitted from the telephone interface 321′ to the interface management module 303′ (step 827), then relayed by the interface management module 303′ to the interface management module 303 (step 826), and then relayed by the interface management module 303 to the telephone interface 331 (step 825).

Let us consider the case where the telephone terminal connected to the telephone interface 331 ends the telephone communication. In a step 828, the user onhooks the handset of said telephone terminal, which generates an event at the telephone interface 331 that is propagated to the interface management module 303. The interface management module 303 transcribes this event as a corresponding message and transmits this message to the interface management module 203 in a step 829. The interface management module 203 transcribes this message as a corresponding event and transmits this event to the telephone call management module 201 in a step 830. In a step 831, the telephone call management module 201, potentially according to the predetermined rules stored by the configuration unit 202, in response transmits to the interface management module 203 an event representing said onhooking of the handset, which is intended for the telephone interface 321′. The interface management module 203 transcribes this event as a corresponding message and transmits this message to the interface management module 303′ in a step 832. The interface management module 303′ transcribes the message as an event representing said handset onhooking and transmits this event to the telephone interface 321′ in a step 833, which causes the sending, over the telephone line concerned, of signalling signals, or messages, representing said handset onhooking.

In a step 834, the telephone call management module 201 transmits to the interface management module 203 a command to release the voice data path between the telephone interface 321′ and the telephone interface 331. The interface management module 203 transcribes this command as a corresponding message and transmits this message to the interface management module 303 in a step 835, as well as to the interface management module 303′ and a step 836. The interface management module 303 and the interface management module 303′ then interact so as to release the path previously created via the communication network 120. The interface management module 303 configures the slave device 111 and the interface management module 303′ configures the slave device 112 so as to release the path.

In view of the examples presented in relation to FIGS. 5 to 8, a person skilled in the art is in a position also to implement the telephony system in the context of:

an outgoing call through a telephone line connected to a slave device and initiated via a telephone terminal connected to the master device;

an outgoing call through a telephone line connected to a first slave device and initiated via a telephone terminal connected to a second slave device;

an outgoing call through a telephone line connected to a slave device and initiated via a telephone terminal connected to this same slave device;

an incoming call through a telephone line connected to a slave device and offhooked via a telephone terminal connected to the master device;

an incoming call through a telephone line connected to the master device and offhooked via a telephone terminal connected to the master device;

an incoming call through a telephone line connected to a slave device and offhooked via telephone terminal connected to this same slave device.

In a particular embodiment, each slave device 111, 112 comprises means for detecting unavailability of the master device 110 via the communication network 120 and, when the unavailability of the master device is detected, the interface management module 303 generates a busy tone via the telephone interface 331, 332, in response to receiving an event representing a handset offhooking via said telephone interface 331, 332.

The unavailability of the master device 110 may be detected following an event of disappearance of the master device 110 of the communication network 120, or following a predetermined number of non-responses from the master device 110 to actions by the slave device 111, 112.

In yet another particular embodiment, when at least one telephone line is free and in response to an event representing a handset offhooking via a telephone interface to which a telephone terminal is connected, the telephone call management module 201 transmits to the interface management module 203 a command to activate a dialling invitation tone sent to said telephone interface, as already presented in relation to FIGS. 5 and 6, and otherwise the telephone call management module 201 transmits to the interface management module 203 a busy tone activation command adressed to said telephone interface.

1. A telephony system comprising a plurality of devices including a master device at least one slave device connected by a communication network, the system being intended to be connected to at least one telephone line and to at least one telephone terminal, each device comprising at least one telephone interface adapted for connecting at least one respective telephone line and/or a telephone interface adapted for connecting at least one respective telephone terminal,
wherein the master device comprises a telephone call management module and wherein said devices are adapted for switching to the telephone call management module any event issuing from a telephone interface and relating to an incoming call or to an outgoing call, and wherein said devices are further adapted for switching to a telephone interface any command sent by the telephone call management module and addressed to said telephone interface.

2. The telephony system according to claim 1, wherein each event and each command transmitted via the communication network is transmitted in the form of a message, and in that there exists a bijective relationship between events and commands on the one hand and messages on the other hand.

3. The telephony system according to claim 2, wherein each device comprises an interface management module adapted for performing a transcription between events and commands on the one hand and messages on the other hand, and the interface management module of the master device is further adapted for transmitting to the telephone call management module any event issuing from a telephone interface and relating to an incoming call or to an outgoing call and for receiving from the telephone call management module any command addressed to a telephone interface.

4. The telephony system according to claim 3, wherein each interface management module is further adapted for managing the connection of voice data through the communication network.

5. The telephony system according to claim 1, wherein the telephone call management module is adapted for analysing the outgoing call number, and each device is adapted for switching to the telephone call management module an event representing each digit dialled by a telephone terminal user and detected by a said telephone interface to which said telephone terminal is connected.

6. The telephony system according to claim 1, wherein each slave device is adapted for:
detecting unavailability of the master device via the communication network, and
each slave is adapted for, when the unavailability of the master device is detected,
generating a busy tone via a telephone interface adapted for connecting at least one telephone terminal, in response to receiving an event representing the handset being off hooked via said telephone interface.

7. The telephony system according to claim 1, wherein the telephone call management module implements, upon receiving a handset off hooking event coming from a telephone interface adapted for connecting a telephone terminal:
transmitting a dialling invitation tone activation command addressed to said telephone interface, when at least one telephone line is free;
transmitting a busy tone activation command addressed to said telephone interface, when no telephone line is free.

8. A method implemented by a telephony system comprising a plurality of devices including a master device and at least one slave device connected by a communication network, said system being connected to at least one telephone line and to at least one telephone terminal, each device comprising at least one telephone interface connected to at least one respective telephone line and/or a telephone interface connected to at least one respective telephone terminal,
wherein, the master device comprising a telephone call management module, said devices switch to the telephone call management module any event issuing from a telephone interface and relating to an incoming call or to an outgoing call, and switch to a telephone interface any command issued by the telephone call management module and addressed to said telephone interface.
